(19) United States
(12) Patent Application Publication
(10) Pub. No.: US 2020/0385617 A1
(43) Pub. Date: Dec. 10, 2020

(54) PARTICLE BINDER AND DUST PALLIATIVE COMPOSITION AND METHOD OF MAKING

(71) Applicant: NW Straw Pulp, LLC., Dayton, WA (US)

(72) Inventor: Keith C. Kuykendall, Waitsburg, WA (US)

(73) Assignee: NW Straw Pulp, LLC., Dayton, WA (US)

(21) Appl. No.: 16/891,412

(22) Filed: Jun. 3, 2020

Related U.S. Application Data
(60) Provisional application No. 62/858,614, filed on Jun. 7, 2019.

(51) Int. Cl. C09K 3/22

(52) U.S. Cl. CPC C09K 3/22

(57) ABSTRACT

A particle binder and dust palliative composition is disclosed. The particle binder and dust palliative composition may comprise a biopolymer composition derived from wheat straw, alfalfa, or other cereal grain straws. The biopolymer composition may include inorganic material, lignin, and polysaccharides. The lignins are polydisperse and have an average molecular weight of between 3500 and 5500 Daltons.

### FIELD OF THE INVENTION

This disclosure generally relates to dust control and particle binding compositions and, more particularly, to dust control and particle binding compositions containing a biopolymer composition.

### BACKGROUND

Control of dust generation from gravel and/or dirt surfaces, roads, parking lots, construction sites, and commercial/industrial processing is commonly practiced. In addition, manufacturing processes that generate dust (e.g., feed and fuel pellet mills, coal handling, lumber yards, etc.) may also benefit from dust control remedies. Particle binding agents are commonly used to improve the physical structure of prilled, granulated, and pelletized products, and to reduce dust generated during the manufacturing and handling processes. Furthermore, soil stabilization products are applied to flat or sloped surfaces exposed to vehicle traffic, wind, or rain to reduce particle movement, erosion, and degradation. Application of wetting agents are commonly used to suppress dust. It is well known that water and chloride-based aqueous solutions, such as magnesium chloride, calcium chloride, and sodium chloride (rock salt), may serve as dust suppressants when applied to surfaces and dust-generating processes. While varying in their effectiveness, such wetting agents may present certain drawbacks such as rapid evaporation, corrosivity, and high water solubility resulting in run-off to the environment, aggregate degradation, increased frequency of application and excessive product usage. Consequently, there is a need for improved dust control and soil stabilization products, and for methods which reduce dust generation and soil movement.

The present disclosure is designed to solve the problems described above.

### SUMMARY

In accordance with one aspect of the present disclosure, a particle binder and dust palliative composition is disclosed. The particle binder and dust palliative composition may comprise a biopolymer composition derived from wheat straw, alfalfa, or other cereal grain straws. The biopolymer composition may comprise inorganic material, lignin, and polysaccharides. The lignins are polydisperse and have an average molecular weight of between 3500 and 5500 Daltons.

In accordance with another aspect of the present disclosure, a particle binder and dust palliative composition is disclosed. The particle binder and dust palliative composition may comprise water, and a sulfonated biopolymer composition derived from wheat straw, alfalfa, or other cereal grain straws. The biopolymer composition may include inorganic material, lignin, and polysaccharides.

In accordance with another aspect of the present disclosure, a method of making a particle binder and dust palliative composition is disclosed. The method may comprise obtaining a dilute lignin pulping liquor composition derived from wheat straw, alfalfa, or other cereal grain straws. The dilute liquor composition may include water, inorganic material, lignin, and polysaccharides. The method may further comprise filtering the dilute liquor composition to remove undissolved fiber related solids and concentrating the dilute liquor to provide a biopolymer composition. The biopolymer composition may provide the particle binder and dust palliative composition.

These and other aspects and features of the present disclosure will be more readily understood when read in conjunction with the accompanying drawings.

### BRIEF DESCRIPTION OF THE DRAWINGS

FIG. 1 is a flowchart illustrating a series of steps that may be involved in making the dust palliative composition of the present disclosure.

FIG. 2 is a flowchart illustrating a series of steps that may be involved in making a first variant of a sulfonated biopolymer according to the present disclosure.

FIG. 3 is a flowchart illustrating a series of steps that may be involved in making a second variant of a sulfonated biopolymer according to the present disclosure.

### DETAILED DESCRIPTION OF THE DISCLOSURE

While the invention described herein may be embodied in many forms, there will herein be described in detail one or more embodiments with the understanding that this disclosure is to be considered an exemplification of the principles of the invention and is not intended to limit the disclosure to the specific embodiments. Aspects of the different embodiments can be combined with or substituted for one another.

The present disclosure pertains to particle binder and dust palliative compositions and a method of making the particle binder and dust palliative compositions. As a non-limiting application, the compositions may be applied to various surfaces (e.g., roadways, driveways, parking lots, construction sites, and other disturbed soil areas) to reduce or prevent the generation of dust and soil movement on or within the target surface. Additionally, the compositions may be used to reduce dust in various industrial manufacturing and handling processes, and/or to improve the physical structure of prilled, granulated, and pelletized products. As explained further below, the particle binder and dust palliative compositions include a biopolymer composition which serves as a novel particle binding agent. Optionally, the particle binder and dust palliative compositions may include a chloride-based salt blended with the biopolymer composition, with the biopolymer composition serving as a performance enhancer of the chloride-based salt. The biopolymer composition is a lignin/hemicellulose co-product produced during pulp processing of non-wood sources including wheat straw, alfalfa, or other cereal grain straws. This biopolymer composition is derived from pulping liquor separated from the cellulose material during pulp processing and is further processed into the particle binder and dust palliative composition. The use of the biopolymer composition as a particle binder and dust control agent provides an industrial application for excess wheat straw residue remaining in fields after wheat straw harvesting.

According to one embodiment, the particle binder and dust palliative composition includes a biopolymer composition derived from wheat straw, alfalfa, or other cereal grain straws. The biopolymer composition is obtained as a lignin/hemicellulose co-product from pulp processing of non-wood sources including wheat straw, alfalfa, or other cereal grain straws such as, but not limited, to rice straw, barley straw, oat straw, and flax straw. The biopolymer composition includes inorganic material, and a complex copolymer of naturally-occurring lignin and polysaccharides, as well as unbonded lignin and polysaccharides. As explained further below, the lignin and polysaccharides in the biopolymer composition are chemically distinct from lignin and polysaccharides obtained from wood sources during kraft pulping processes or sulfite pulping processes.

Optionally, the particle binder and dust palliative composition of the present disclosure may include a metal chloride salt. If a metal chloride salt is included, the biopolymer composition may enhance the performance of the metal chloride salt. The chloride-based salt may be selected from magnesium chloride, calcium chloride, sodium chloride, and combinations thereof.

Optionally, the biopolymer composition may be a sulfonated biopolymer composition. The sulfonated biopolymer composition has a sulfonated aromatic ring which increases the metal complexing capacity. Therefore, this embodiment may have a stronger binding effect in some cases. The sulfonated biopolymer may be a first variant or a second variant. The first variant is formed by oxidizing the biopolymer composition with ammonium persulfate to remove some methoxl groups, then sulphonating the aromatic ring with sodium sulfite and formaldehyde. The second variant is formed by reacting the biopolymer composition with sulfuric acid.

The biopolymer composition may be aqueous or dry. If aqueous, the biopolymer composition may include solids, wherein the total solids in the biopolymer composition includes dissolved solids and, in some cases, a small fraction of undissolved solids. The undissolved solids may include suspended or colloidal solids.

In one embodiment, the biopolymer composition comprises about 45-60% by weight water on a wet basis, about 5-20% by weight lignin on a dry basis, about 5-20% by weight polysaccharides and saccharinic acids on a dry basis, and about 40-55% by weight inorganic material on a dry basis. As used herein, “on a wet basis” refers to the weight percentage of water as characterized when the composition is in aqueous form. As used herein, “on a dry basis” refers to the weight percentages of the individual components as characterized when the composition is in dry or solid form, and the water content is excluded. Thus, although the components may be in an aqueous solution, their contents are characterized when the composition is dry when reported on a dry basis.

In one embodiment, the particle binder and dust palliative composition may include 5-95% by weight metal chloride salt on a dry basis, and 5-95% by weight of the biopolymer composition on a dry basis (see Table 1). The most applicable ratio of biopolymer to metal chloride salt may vary depending on the choice of metal chloride salt, and the soil and ambient conditions of the site of intended application. Based on testing, some possible ratios of biopolymer to metal chloride salt may include: 5%/95%, 20%/80%, 30%/70%, 60/40%, 50/50%, 40/60%, 70/30%, 80/20%. Of course, any other ratio suitable for the application may be used.

The water content, or the weight percent of water on a wet basis, may vary from 45 to 80% to achieve desired viscosity, penetration, and/or surface coverage requirements (see Table 1).

TABLE 1
Example Particle Binder and Dust Palliative Composition

| Component | Percent by weight | |
|---|---|---|
| water | 45-80% | (wet basis) |
| metal chloride salt | 5-95% | (dry basis) |
| biopolymer composition | 5-95% | (dry basis) |

The particle binder and dust palliative compositions of the present disclosure may have a pH of 7-11, and a specific gravity of 1.05-1.35.

The biopolymer composition includes inorganic material, and a complex copolymer of naturally-occurring lignin and polysaccharides, as well as unbonded lignin and polysaccharides. The biopolymer composition is obtained as a lignin/hemicellulose co-product from pulp processing of non-wood sources including wheat straw, alfalfa, or other cereal grain straws such as, but not limited, to rice straw, barley straw, oat straw, and flax straw.

The biopolymer composition may include both bonded and unbonded polysaccharides. The bonded polysaccharides may be bonded to the lignin as a copolymer. The polysaccharides may at least include polydisperse hemicellulose of varying molecular sizes. The lignin may be polydisperse and of varying molecular sizes. The average molecular weight may be between 3500 and 5500 Daltons. The results of tests on one embodiment of the biopolymer composition are shown in Table 2 below. The polydisperse lignin and the polydisperse hemicellulose can be present as a copolymer, or each of the polydisperse lignin and the polydisperse hemicellulose can be present separately. The polydispersities of the lignin and hemicellulose in the biopolymer composition of the present disclosure are distinct from the polydispersities of lignins and hemicellulose derived from wood species.

TABLE 2
Molar Mass Distribution of Biopolymer Lignin
Fraction (Gel Permeation Chromatography data)

| Number-average | Peak molecular | Weight-average | Z-average | |
|---|---|---|---|---|
| molecular weight | weight (Mp) | molecular weight | molecular weight | |
| (Mn) (Daltons) | (Daltons) | (Mw) (Daltons) | (Mz) (Da) | Mw/Mn |
| 3878-5120 | 4304-6638 | 11288-22287 | 25570-148361 | 3.4-5.6 |

The lignin may have a high content of hydroxyl (OH) and carboxylic acid (COOH) groups as compared to lignin derived from wood-species pulping processes (see Table 3 below). The methoxy (OMe) group content is provided in Table 4 below. The hydroxyl, carboxylic acid, and methoxy group contents of the lignin of the present disclosure are distinct from the hydroxyl, carboxylic acid, and methoxy group contents of lignins derived from wood sources.

TABLE 3
Hydroxyl (OH) and Carboxyl (COOH) Group
Content of Biopolymer Lignin Fraction.

| | Millimole/gram |
|---|---|
| Group | (mmol/g) |
| aliphatic OH | 1.38-2.88 |
| syringyl, condensed | 0.22-0.57 |
| guaiacyl, catechol | 0.27-0.67 |
| aromatic OH | 0.48-1.24 |
| carboxyl COOH | 0.31-0.92 |
| Total OH | 1.87-4.12 |

TABLE 4
Methoxy (OMe) Group Content of Biopolymer Lignin Fraction.

| Average OMe, | Standard Deviation, | RSD (relative standard |
|---|---|---|
| mmol/g | mmol/g | deviation), % |
| 2.72-4.72 | 0.03-0.10 | 0.54-3.60 |

The polysaccharides in the biopolymer composition includes a mixture of five and six carbon sugars. According to sugar analysis performed by acid methanolysis, the predominant five carbon sugars include xylose (Xyl) and arabinose (Ara), and the predominant six carbon sugars include glucose (Glc), galactose (Gal), galacturonic acid (GalUA), glucuronic acid (GlcUA), and 4-O-methylglucouronic acid (4OMeGlcUA). In addition to these sugars, the polysaccharides further include sugar units of rhamnose (Rha), fucose (Fuc), and mannose (Man). The biopolymer composition contains little to no fructose and, therefore, little to no sucrose (a disaccharide of glucose and fructose). In addition to these, the biopolymer composition further includes saccharinic acids. In one embodiment, the polysaccharides may have about 60% five carbon sugars and about 40% six carbon sugars. The biopolymer composition has a low concentration of low molecular weight saccharinic acids derived from the sugars when treated under alkaline conditions. Isosaccharinic acids are formed from the six carbon sugars, and a comparable acid is formed from xylose. These acids form strong and stable complexes with di- and trivalent cations. The sugar profile of the polysaccharides in the biopolymer composition of the present disclosure is distinct from the sugar profile of polysaccharides derived from wood pulping processes.

The biopolymer composition contains a high content of alkyl and aromatic groups. The lignin reacts easily at the β-O-4 position forming alkyl and aromatic hydroxyl groups. In addition, the lignin of the biopolymer composition of the present disclosure has a higher content of carboxylic acid groups and a higher oxygen/carbon (O/C) ratio than lignins derived from wood pulping processes (see Table 2). The high content of hydroxyl and carboxylic acid (COOH) (see Table 3) provides the biopolymer composition with a high cation exchange capacity, with all cations exchanging with the lignin. The polysaccharides in the biopolymer composition also contain hydroxyl and carboxylic acid groups. Reaction of the lignin β-O-4 cross-linked groups leads to low lignin molecular weights (from about 2,000 to about 20,000). The low lignin molecular weight combined with a high hydroxyl group content leads to a higher lignin reactivity.

A portion of the polysaccharides in the biopolymer composition are chemically bonded to lignin and tend to keep the copolymer dissolved at a pH equal to 7.5 and above. By contrast, other alkaline lignins have little or no polysaccharides and are soluble in water across the pH range of 1-14. Thus, the biopolymer is less soluble at a pH below 7.5 than other alkali lignins. However, the sulfonated biopolymer composition may have a wider pH solubility range. The first variant may have a solubility range of 1-14. The second variant may have a solubility range of 4-8. The most effective option will depend at least in part on the type of soil, dust, or particles on which the particle binder and dust palliative composition is intended to be used.

The amorphous nature of the lignin/hemicellulose copolymers results in medium and large molecules (heavy molecular weight), providing the copolymer with moderate polydispersity (Table 1). The density of the biopolymer composition varies from about 1.05 to 1.25 g/ml depending on the concentration of solids. This density will cause fine droplets to settle rapidly during spray application. Additionally, the polymeric lignin/polysaccharide material of the biopolymer composition becomes sticky/tacky when dried and adheres to and binds together small particles, while remaining pliable.

Furthermore, the biopolymer composition of the present disclosure acts as a corrosion inhibitor as the copolymer ion-exchange sites attach to metal surfaces, forming a surface layer that protects against corrosion by salts of magnesium, calcium, and sodium. As such, the particle binder and dust palliative composition of the present disclosure is less corrosive to vehicles and concrete surfaces than chloride-based salts alone. The sulfonated biopolymer composition has increased ion exchange sites, allowing a great metal complexing capacity. Therefore, the sulfonated biopolymer composition may be even more effective at protecting against corrosion.

In addition, the metal complexing capacity of the biopolymer composition from the ion exchange sites allows the biopolymer to more readily bind with the soil particles. This improves the binding and palliative capacity of the composition.

Moreover, the biopolymer composition of the present disclosure improves surface bonding and enhances the adhesion of chloride-based salts to particles, thereby minimizing run-off and associated chloride losses to the environment. The reduced run-off is due to the complexing action of the copolymer with chlorides and binding with the soil particles. This translates to chloride savings and prolonged activation. Moreover, the complexed biopolymer with chloride prevents a portion of the chloride from becoming airborne after dehydration and being lost to the environment. This reduces waste and increases the duration of the particle binding activity.

Additionally, the biopolymer composition is humectant, attracting ambient moisture and improving the duration of particle binding and dust suppression functions without becoming brittle and hard. It also acts as a rheology modifier and tackifier, increasing the viscosity of the particle binder and dust palliative, and improving the adherence of the product to small particles. Even further, the biopolymer composition serves as a colorant and improves visibility of the dust palliative when applied to surfaces.

In testing, the biopolymer composition out-performed both MgCl2 based compositions and lignin sulfonate based compositions as a particle binder and dust palliative in several parameters. First, the biopolymer composition slowed less slump after rain conditions, indicating greater water resistance and strength. Second, the biopolymer appeared to leach less that the other compositions. Finally, the biopolymer had the highest bearing capacity.

In penetration tests for road stability, the particle binder and dust palliative composition performed significantly better than untreated earth. With proper curing, the treatment prevented dust and corrugation for over a month. Moreover, the biopolymer based treatment remains after rainfall, unlike MgCl2 treatments which can soften with excess moisture.

The particle binder and dust palliative composition may be non-toxic to waterways, animals, and plants. Standard acute toxicity tests were run for a deicer composition in accordance with the present disclosure containing magnesium chloride as the metal chloride salt. No statistically significant chronic toxicity at any tested concentration was found in survival tests for Fathead Minnow (Pimephales promelas), Ceridaphnia dubia or Rainbow Trout (Oncorhynchus mykiss).

### Method of Making Particle Binder and Dust Palliative Compositions

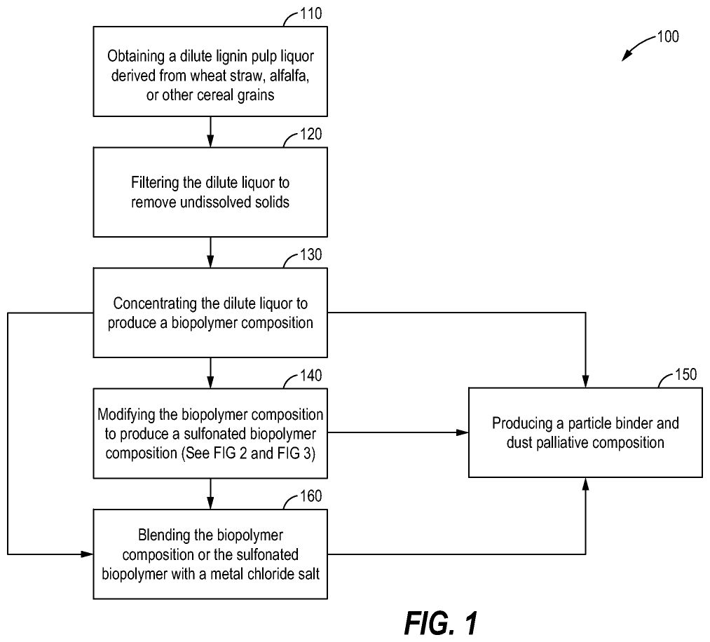

A method which may be used for producing the particle binder and dust palliative composition is depicted in FIG. 1. Initially, a dilute pulping liquor is obtained as a dilute lignin/hemicellulose co-product from pulp processing of wheat straw, alfalfa, or other cereal grain straws (see block 110). The dilute pulping liquor is an aqueous solution including inorganic material, a polydisperse copolymer of lignin and polysaccharides (hemicellulose), as well as unbonded lignin and polysaccharides (hemicellulose). The dilute liquor contains approximately 2-12% total solids including both dissolved solids and undissolved fine fibrous solids. Subsequently, the dilute liquor is further processed to remove the undissolved solids through a combination of solid removal steps including multiple settling and decanting steps, and filtration through mechanical systems, such as through a 100 micron bag-type filter, a frame and plate disk filter, and/or a decanter centrifuge (block 120). The filtration steps to remove undissolved solids may be optionally assisted with one or more surfactants, dispersants, flocculants, and/or coagulants. For instance, the filtration step may be assisted with one or more surfactants to aid in the separation of fibrous fines. The total solids remaining after the filtration step includes mostly dissolved solids and a small fraction of undissolved solids (including colloidal solids). Optionally, one or more cationic, anionic, and/or nonionic surfactants, coagulants, and/or dispersants may be added to affect the suspension of precipitates of lignin/hemicellulose under varied concentrations and pH ranges.

The filtered biopolymer composition is concentrated to reduce the water content typically to about 45-60% by weight (block 130) and create the biopolymer composition referred to throughout this disclosure. In one specific embodiment, the biopolymer is dried to minimize the water content. For such purposes, suitable drying/evaporation technologies include, but are not limited to, multi-effect evaporation, spray drying, freeze drying, and/or drum drying. Optionally, one or more cationic, anionic, and/or nonionic surfactants, coagulants, and/or dispersants may be added to the biopolymer composition to affect the suspension of precipitates of lignin/hemicellulose under varied concentrations and pH ranges. Optionally, a defoaming agent may be used to reduce foaming of the biopolymer composition during concentration and subsequent blending with the metal chloride salts. The biopolymer composition may provide the particle binder and dust palliative composition (block 150).

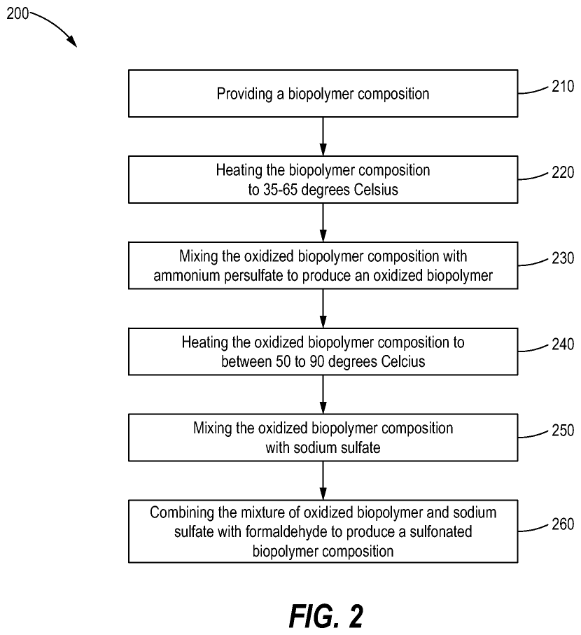

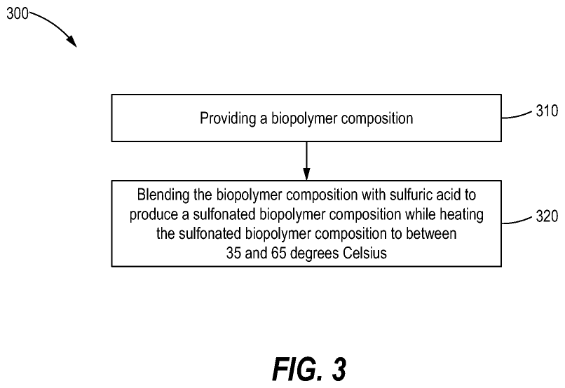

The biopolymer composition may be further processed into a sulfonated biopolymer composition, as shown in block 140. The sulfonated biopolymer composition may be either the first variant (see FIG. 2) or the second variant (see FIG. 3). Either variant of the sulfonated biopolymer may also provide the particle binder and dust palliative composition (block 150).

The method of producing the first variant of the sulfonated biopolymer composition is more fully described in FIG. 2 and begins with providing the biopolymer composition of block 130 (block 210). The biopolymer composition is heated to between 35 and 65 degrees Celsius (block 220) and then mixed with ammonium persulfate (block 230). In one embodiment, the amount of ammonium persulfate may be 5% of the weight of dry solids in the biopolymer. The mixing may take place over at least 10 minutes in some embodiments. The ammonium persulfate oxidizes the biopolymer composition and removes some methoxyl groups, producing an oxidized biopolymer composition. The oxidized biopolymer composition is heated to between 50 and 90 degrees Celsius (block 240). In some embodiments, it may be held at temperature for around one hour to allow the reaction to complete. Next, the oxidized biopolymer may be mixed with sodium sulphite (block 250). It may be mixed for around 30 minutes. The sodium sulfite may be in a crystalline form. In one embodiment, the amount of sodium sulfite may be 7% of the weight of dry solids in the biopolymer. Finally, the mixture of sodium sulfite and the oxidized biopolymer may be combined with formaldehyde (block 260). In one embodiment, the formaldehyde may be at 37% concentration. In one embodiment, the amount of formaldehyde may be 5% of the weight of dry solids in the biopolymer. The sodium sulfite and formaldehyde react with the biopolymer to sulfo-methylate the aromatic ring and produce a sulfonated biopolymer composition. The sulfonated biopolymer composition may be held at temperature for three hours to allow the reaction to complete.

The method of producing the second variant of the sulfonated biopolymer composition is more fully described in FIG. 2 and begins with providing the biopolymer composition of block 130 (block 310). The biopolymer is blended with sulfuric acid to sulfonate the aromatic ring (block 320). The sulfuric acid may be added slowly to prevent excessive heat generation. While the blending is taking place, the mixture is heated to between 35 and 65 degrees Celsius. In one embodiment, 49% sulfuric acid is used at a ratio of between 2% to 15% of the weight of dry solids in the biopolymer composition. Of course, other strengths of acid may be used, with the ratio of acid to biopolymer composition adjusted accordingly.

Optionally, the biopolymer composition or either variant of the sulfonated biopolymer composition may then be blended with the metal chloride salt in various ways (block 160). For instance, the biopolymer composition in dry or liquid form may be blended with a dry or a liquid form of the metal chloride salt. In this regard, liquid-to-liquid, liquid-to-dry, dry-to-liquid, and dry-to-dry mixing may require different mixing methods. Water or buffered water may be added to the mixture if the components are blended in dry form. The filtered or filtered and concentrated biopolymer composition blended with the metal chloride salt may provide the particle binder and dust palliative composition (block 150).

Optionally, a preservative may be used to mitigate biological degradation of the biopolymer composition.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims.

What is claimed is:

1. A particle binder and dust palliative composition comprising a biopolymer composition derived from wheat straw, alfalfa, or other cereal grain straws, the biopolymer composition including inorganic material, lignin, and polysaccharides, the lignins being polydisperse and having an average molecular weight of between 3500 and 5500 Daltons.

2. The particle binder and dust palliative composition of claim 1, further comprising a metal chloride salt.

3. The particle binder and dust palliative composition of claim 3, wherein the metal chloride salt is selected from the group consisting of magnesium chloride, calcium chloride, and sodium chloride

4. The particle binder and dust palliative composition of claim 2, wherein the particle binder and dust palliative composition comprises 5-95% of the biopolymer composition on a dry basis, and 5-95% of the metal chloride salt on a dry basis.

5. The particle binder and dust palliative composition of claim 1, wherein the biopolymer composition is a sulfonated biopolymer.

6. The particle binder and dust palliative composition of claim 2, wherein the particle binder and dust palliative composition further comprises 45-80% water on a wet basis, with the remainder being 5-95% of the metal chloride salt on a dry basis, and 5-95% of the biopolymer composition on a dry basis.

7. A particle binder and dust palliative composition, comprising:
water; and
a sulfonated biopolymer composition derived from wheat straw, alfalfa, or other cereal grain straws, the sulfonated biopolymer composition including inorganic material, lignin, and polysaccharides.

8. The particle binder and dust palliative composition of claim 7, further comprising a metal chloride salt.

9. The particle binder and dust palliative composition of claim 8, wherein the metal chloride salt is selected from the group consisting of magnesium chloride, calcium chloride, and sodium chloride.

10. The particle binder and dust palliative composition of claim 7, wherein the sulfonated biopolymer composition is produced by reacting the biopolymer composition with ammonium persulfate, sodium sulfite, and formaldehyde.

11. The particle binder and dust palliative composition of claim 7, wherein the sulfonated biopolymer composition is produced by reacting the biopolymer composition with sulfuric acid.

12. The particle binder and dust palliative composition of claim 8, wherein the particle binder and dust palliative composition comprises:
45-80% water on a wet basis;
5-95% of the metal chloride salt on a dry basis; and
5-95% of the biopolymer composition on a dry basis.

13. A method of making a particle binder and dust palliative composition, comprising:
obtaining a dilute lignin pulp liquor composition derived from wheat straw, alfalfa, or other cereal grain straws;
filtering the dilute liquor to remove undissolved fiber related solids; and
concentrating the dilute liquor to provide a biopolymer composition comprising about 25-55% by weight of total solids to provide the particle binder and dust palliative composition.

14. The method of claim 13, further comprising blending the biopolymer composition with a metal chloride salt, the blend of metal chloride salt and biopolymer composition providing the particle binding and dust palliative composition.

15. The method of claim 14, wherein the particle binding and dust palliative composition comprises 5-95% of the biopolymer composition on a dry basis, and 5-95% of the metal chloride salt on a dry basis.

16. The method of claim 14, wherein the metal chloride salt is selected from the group consisting of magnesium chloride, calcium chloride, and sodium chloride.

17. The method of claim 13, further comprising modifying the biopolymer composition to produce a sulfonated biopolymer composition, the sulfonated biopolymer providing the particle binding and dust palliative composition.

18. The method of claim 17, wherein the sulfonated biopolymer composition is produced by reacting the biopolymer composition with ammonium persulfate, sodium sulfite, and formaldehyde.

19. The method of claim 17, wherein the sulfonated biopolymer composition is produced by reacting the biopolymer composition with sulfuric acid.

20. The method of claim 13, wherein the lignins are polydisperse and have an average molecular weight of between 3500 and 5500 Daltons.
